(19) United States
(12) Patent Application Publication
(10) Pub. No.: US 2025/0015268 A1
(43) Pub. Date: Jan. 9, 2025

(54) POSITIVE ELECTRODE COMPOSITE ACTIVE MATERIAL, LITHIUM ION SECONDARY BATTERY, AND PRODUCTION METHOD FOR LITHIUM ION SECONDARY BATTERY

(71) Applicant: KANEKA CORPORATION, Osaka-shi, Osaka (JP)

(72) Inventors: Mitsuyasu IMAZAKI, Settsu-shi (JP); Takashi KIKUCHI, Settsu-shi (JP); Junichi IMAIZUMI, Settsu-shi (JP)

(21) Appl. No.: 18/700,422

(22) PCT Filed: Oct. 11, 2022
(86) PCT No.: PCT/JP2022/037846

§ 371 Date: Apr. 11, 2024

(30) Foreign Application Priority Data
Oct. 14, 2021 (JP) 2021-169108

(51) Int. Cl. H01M 4/36; H01M 4/02; H01M 4/485; H01M 4/505; H01M 10/0525

(52) U.S. Cl. CPC H01M 4/366; H01M 4/485; H01M 4/505; H01M 10/0525; H01M 2004/021; H01M 2004/027; H01M 2004/028

(57) ABSTRACT

The present invention provides a positive electrode composite active substance and a lithium ion secondary battery in which a coating layer covers a surface of an oxide active substance, and a resistance loss due to the coating layer can be suppressed while generation of gas due to decomposition of a nonaqueous electrolyte solution is suppressed as compared with a conventional case. A positive electrode composite active substance constituting a part of a positive electrode of a lithium ion secondary battery using a nonaqueous electrolyte solution as an electrolyte, the positive electrode composite active substance including: an oxide active substance; and a coating layer covering a surface of the oxide active substance, in which the coating layer has lithium ion conductivity, and a grain boundary resistance of the coating layer is 3 times or more and 20 times or less larger than a charge transfer resistance of the oxide active substance.

### TECHNICAL FIELD

The present invention relates to a positive electrode composite active substance, a lithium ion secondary battery, and a production method for a lithium ion secondary battery.

### BACKGROUND ART

Conventionally, lithium ion secondary batteries have attracted attention as applications such as in-vehicle power supplies for electric vehicles, and further increase in energy density is required.

Examples of the positive electrode active substance of the lithium ion secondary battery include lithium nickel manganese oxide (hereinafter, also referred to as LNMO) (for example, Patent Document 1).

LNMO has an operating voltage of 4.7 V based on a lithium deposition potential, which is higher than that of a conventional lithium insertion material (for example, lithium cobaltate: 4 V) used as a positive electrode active substance material, and is expected for high energy density.

However, since LNMO has a high operating voltage and the reaction proceeds in an oxidizing atmosphere, there is a problem that a part of the nonaqueous electrolyte solution is decomposed and gas is generated.

Therefore, Patent Document 2 proposes a method in which a surface of the positive electrode active substance is covered with a solid electrolyte, and the surface of the positive electrode active substance is not directly exposed to a nonaqueous electrolyte solution to suppress the generation of gas due to the decomposition of the nonaqueous electrolyte solution on the positive electrode active substance.

### PRIOR ART DOCUMENT

### Patent Document

Patent Document 1: JP 2021-051987 A
Patent Document 2: WO 2020/049843 A

### DISCLOSURE OF INVENTION

### Technical Problem

However, in the positive electrode composite active substance of Patent Document 2, since the thickness of the solid electrolyte covering the surface of the positive electrode active substance is large, the gas generation amount can be suppressed, but the resistance of the positive electrode composite active substance is greatly increased due to the presence of the solid electrolyte, and there is a problem that a resistance loss in the fixed electrolyte is large.

Therefore, the present inventors have experimentally produced and studied a lithium ion secondary battery using a positive electrode composite active substance in which the thickness of the solid electrolyte is reduced, following the positive electrode composite active substance of Patent Document 2. As a result, when the thickness of the solid electrolyte is reduced, an increase in resistance of the positive electrode composite active substance due to the presence of the solid electrolyte is reduced, but there has been a problem in that the effect of suppressing gas generation is also reduced.

Furthermore, the experimentally produced positive electrode composite active substance had problems of quality dispersion from forming to forming and poor yield.

Therefore, an object of the present invention is to provide a positive electrode composite active substance and a lithium ion secondary battery in which a coating layer covers a surface of an oxide active substance, and a resistance loss due to the coating layer can be suppressed while generation of gas due to decomposition of a nonaqueous electrolyte solution is suppressed as compared with the conventional case. Furthermore, an object of the present invention is to provide a production method for a lithium ion secondary battery capable of improving a yield and securing a certain quality as compared with the related art.

### Solution to Problem

In order to solve the above problems, the present inventors have studied a relationship between the gas generation amount and the resistance in the positive electrode composite active substance, and found that the waveform of the complex impedance plot of the positive electrode composite active substance in which the positive electrode active substance is coated with the solid electrolyte differs from that of the positive electrode active substance without solid electrolyte coating, and the difference observed is existence of an arc attributed to the grain boundary resistance of the solid electrolyte.

That is, in the positive electrode active substance not coated with the solid electrolyte, a complex impedance plot having one arc attributed to the charge transfer resistance of the positive electrode active substance was confirmed in a frequency range of 0.1 Hz to 1 kHz, whereas in the positive electrode composite active substance coated with the solid electrolyte, a complex impedance plot was confirmed that has at least two arcs including an arc on a low frequency side attributed to the grain boundary resistance of the solid electrolyte in addition to an arc on a high frequency side attributed to the charge transfer resistance of the positive electrode active substance.

Then, as a result of studying a relationship between the arc attributed to the grain boundary resistance and the gas generation amount, the present inventors have found that a magnitude of the arc of the grain boundary resistance has a large correlation with the gas generation amount.

An aspect derived from the above findings is a positive electrode composite active substance constituting a part of a positive electrode of a lithium ion secondary battery using a nonaqueous electrolyte solution as an electrolyte, the positive electrode composite active substance including: an oxide active substance; and a coating layer covering a surface of the oxide active substance, in which the coating layer has lithium ion conductivity, and a grain boundary resistance of the coating layer is 3 times or more and 20 times or less larger than a charge transfer resistance of the oxide active substance.

According to this aspect, as compared with the conventional case, it is possible to suppress the resistance loss due to the coating layer, while suppressing the generation of gas due to the decomposition of the nonaqueous electrolyte solution caused by contact of the oxide active substance with the nonaqueous electrolyte solution.

In a preferred aspect, the coating layer has a grain boundary resistance per unit weight of 0.2 Ω/g or more and 2 Ω/g or less.

According to this aspect, since the grain boundary resistance is small, the resistance loss can be suppressed.

In a preferred aspect, the coating layer has a thickness of 5 nm or more and 50 nm or less.

According to this aspect, the generation of gas can be suppressed even when the thickness of the coating layer is thin.

In a preferred aspect, the coating layer contains phosphorus.

In a preferred aspect, the coating layer contains a lithium phosphate-based lithium ion conductive oxide.

In a more preferred aspect, the lithium ion conductive oxide contains a compound represented by Formula (1) below:

Li_{1+p+q+r}AlₚGa_{q} (Ti, Ge)_{2-p-q}SiᵣP₃₋ᵣO₁₂ (1)
(the Formula (1) satisfies 0<p≤1, 0≤q<1, and 0≤r≤1).

In a preferred aspect, the lithium ion conductive oxide contains a compound represented by Formula (2) below:

LiₐA_{b}D_{c}PO₄ (2)
(in the Formula (2), a, b, and c satisfy 0.9<a<1.1, 0<b≤1, 0≤c<1, and 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y).

In a preferred aspect, the lithium ion conductive oxide contains a compound represented by (3) below and a compound represented by (4) below:

Li_{1+p+q+r}AlₚGa_{q} (Ti, Ge)_{2-p-q}SiᵣP₃₋ᵣO₁₂ (3)
(the Formula (3) satisfies 0<p≤1, 0≤q<1, and 0≤r≤1),

LiₐA_{b}D_{c}PO₄ (4)
(in the Formula (4), a, b, and c satisfy 0.9<a<1.1, 0<b≤1, 0≤c<1, and 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y).

In a preferred aspect, the oxide active substance contains a lithium manganese-based oxide having a spinel-type crystal structure.

One aspect of the present invention is a lithium ion secondary battery including: a positive electrode; a nonaqueous electrolyte solution; and a negative electrode, in which the positive electrode includes a positive electrode composite active substance, the positive electrode composite active substance includes an oxide active substance and a coating layer covering a surface of the oxide active substance, the coating layer has lithium ion conductivity, at least two arcs are calculated when AC impedance measurement is performed at a frequency of 0.1 Hz to 10 kHz and an amplitude of 10 mV in a state of being charged to a charge depth of 50% and a Nyquist plot is calculated, and a diameter of an arc on a low frequency component side among the two arcs is 3 times or more and 20 times or less larger than a diameter of an arc on a high frequency component side.

According to this aspect, the generation of gas due to the decomposition of the nonaqueous electrolyte solution caused by contact of the oxide active substance with the nonaqueous electrolyte solution can be suppressed.

In a preferred aspect, the negative electrode includes lithium titanate as a negative electrode active material.

One aspect of the present invention is a production method for a lithium ion secondary battery that includes a positive electrode including a positive electrode composite active substance, a nonaqueous electrolyte solution, and a negative electrode, the production method including: an active substance forming step of covering a surface of an oxide active substance with a coating layer to form the positive electrode composite active substance; a positive electrode forming step of applying the positive electrode composite active substance to a current collector to form the positive electrode; and a measurement step of measuring a grain boundary resistance of the coating layer in the positive electrode.

According to this aspect, since the gas generation amount can be predicted by measuring the grain boundary resistance, the yield can be improved, and a certain quality can be secured.

A preferred aspect includes a determination step of determining a non-defective product on condition that the grain boundary resistance of the coating layer in the positive electrode falls within a predetermined range.

According to this aspect, since the non-defective product can be so determined, the yield can be further improved.

Furthermore, as a result of studying a relationship between an amount ratio of a fine particle fluid as a material of the coating layer to the oxide active substance and the grain boundary resistance, it has been found that when an amount of the fine particle fluid added to the oxide active substance is increased, a value of the grain boundary resistance increases in a certain amount range, and when the amount exceeds a certain amount, the value of the grain boundary resistance decreases and becomes constant.

Then, even after exceeding the certain amount, the correlation between a size of the arc of the grain boundary resistance and the gas generation amount remained unchanged.

Therefore, one aspect of the present invention is a positive electrode composite active substance constituting a part of a positive electrode of a lithium ion secondary battery using a nonaqueous electrolyte solution as an electrolyte, in which a fine particle fluid is added to an oxide active substance and ground to form a coating layer on a surface of the oxide active substance, in which the fine particle fluid contains lithium phosphate-based lithium ion conductive oxide particles having an average particle size of 10 nm or less, a difference between a grain boundary resistance of the coating layer and a grain boundary resistance of a coating layer is 5% or less, the coating layer is formed on the surface of the oxide active substance by grinding a fine particle fluid having an allowable limit amount to the oxide active substance, and the coating layer is formed by grinding a fine particle fluid in an amount of 50% or less of the allowable limit amount to the oxide active substance.

The “allowable limit amount” as used herein refers to a limit amount that can be maintained in a state of being added. That is, the allowable limit amount for an oxide active substance refers to a limit amount that the oxide active substance can hold.

The “average particle size” as used herein represents an arithmetic average particle size, and can be determined by various methods. For example, the “average particle size” may be determined by direct observation with a microscope such as a transmission electron microscope (TEM) or a scanning electron microscope (SEM), may be determined by calculation from a specific surface area by a specific surface area measurement method (BET method), or may be determined by optical measurement by an X-ray diffraction method (XRD), a dynamic light scattering method (DLS), a laser diffraction/scattering method (LD), or the like. The same applies hereinafter.

According to this aspect, gas generation can be suppressed without substantial change from the case where the allowable limit amount is added, even if the allowable limit amount or more of the fine particle fluid is not added to the oxide active substance, so that the resistance loss due to the coating layer can be suppressed while suppressing the gas generation due to the decomposition of the nonaqueous electrolyte solution as compared with the conventional case. Furthermore, since the fine particle fluid to be used can be reduced, the cost can be reduced.

### Effect of Invention

According to the positive electrode composite active substance and the lithium ion secondary battery of the present invention, it is possible to suppress the resistance loss due to the coating layer while suppressing the generation of gas due to the decomposition of the nonaqueous electrolyte solution as compared with the conventional case.

According to the production method for a lithium ion secondary battery of the present invention, the yield can be improved, and a certain quality can be secured.

### BRIEF DESCRIPTION OF DRAWINGS

FIG. 1 is a cross-sectional view conceptually illustrating a lithium ion secondary battery according to a first embodiment of the present invention.

FIGS. 2A and 2B illustrate Nyquist plots of lithium ion secondary batteries of Experimental Example 1 and Experimental Example 14 of the present invention, where FIG. 2A illustrates Experimental Example 1 and FIG. 2B illustrates Experimental Example 14.

FIGS. 3A and 3B illustrate Nyquist plots of lithium ion secondary batteries of Experimental Example 9 and Experimental Example 12 of the present invention, where FIG. 3A illustrates Experimental Example 9 and FIG. 3B illustrates Experimental Example 12.

FIGS. 4A and 4B are explanatory diagrams illustrating a relationship among a grain boundary resistance, a gas generation amount, and an initial capacity of lithium ion secondary batteries of Experimental Examples 1 to 14 of the present invention, in which FIG. 4A is a graph illustrating a relationship of the gas generation amount with respect to the grain boundary resistance, and FIG. 4B is a graph illustrating a relationship of the initial capacity with respect to the grain boundary resistance.

FIGS. 5A to 5C are model diagrams of a reaction mechanism in the formation process of a coating layer of the present invention, and FIG. 5A to FIG. 5C illustrate a lapse of time.

### BEST MODE FOR CARRYING OUT THE INVENTION

Hereinafter, embodiments of the present invention will be described in detail.

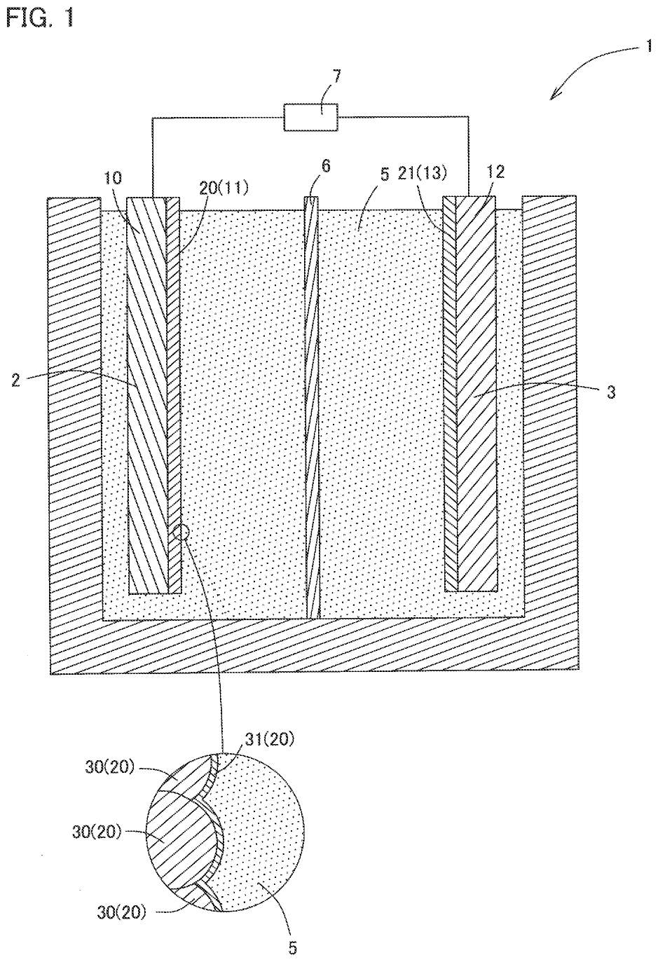

As illustrated in FIG. 1, a lithium ion secondary battery 1 of a first embodiment of the present invention includes a positive electrode 2, a negative electrode 3, a nonaqueous electrolyte solution 5, and a separator 6, and an external load 7 is connected to the positive electrode 2 and the negative electrode 3.

The positive electrode 2 is formed by laminating a positive electrode composite active substance layer 11 on a positive electrode current collector 10, and is an insertion electrode capable of inserting and desorbing lithium ions.

The positive electrode composite active substance layer 11 includes a positive electrode composite active substance 20, a conductive aid, and a binder.

The negative electrode 3 is formed by laminating a negative electrode active substance layer 13 on a negative electrode current collector 12, and is an insertion electrode capable of inserting and desorbing lithium ions.

The negative electrode active substance layer 13 includes a negative electrode active material 21, a conductive aid, and a binder.

The positive electrode composite active substance 20 is a coated positive electrode active substance in which a surface of an oxide active substance 30 is coated with a coating layer 31.

### <Oxide Active Substance 30>

The oxide active substance 30 is a lithium ion conductive active substance, and an average potential of lithium desorption and lithium insertion is preferably 4.5 V or more and 5.0 V or less with respect to a Li deposition potential (also indicated as vs. Li⁺/Li). That is, the oxide active substance 30 preferably has an operation potential of 4.5 V or more and 5.0 V or less based on lithium metal as a single body.

The potential (hereinafter, also referred to as a voltage) (vs. Li⁺/Li) of the lithium ion insertion and desorption reaction can be obtained, for example, by measuring charge/discharge characteristics of a half battery using, the oxide active substance 30 as an operating electrode and lithium metal as a counter electrode, and reading voltage values at the start and end of plateau. In a case where there are two or more plateaus, the plateau of the lowest voltage value may be 4.5 V (vs. Li⁺/Li) or more, and the plateau of the highest voltage value may be 5.0 V (vs. Li⁺/Li) or less.

The oxide active substance 30 is not particularly limited, but is preferably a spinel-type lithium manganese-based oxide represented by Formula (1) described below.

Li₁₊ₓM_{y}Mn_{2-x-y}O₄ (1)

In Formula (1) described above, x and y satisfy 0≤x≤0.2 and 0<y≤0.8, respectively, and M is at least one selected from the group consisting of Al, Mg, Zn, Ni, Co, Fe, Ti, Cu, and Cr.

The oxide active substance 30 may contain, for example, a trace amount of elements other than lithium and manganese, such as Ti, separately from the lithium manganese-based oxide.

In Formula (1) described above, a Ni-substituted lithium manganese compound (LNMO) in which M is Ni is preferable, and in particular, x=0, y=0.5, and M=Ni are preferable, that is, LiNi_{0.5}Mn_{1.5}O₄ is particularly preferable because it has a high charge/discharge cycle stability effect.

A particle size of the oxide active substance 30 is not particularly limited, but a median diameter d50 is preferably 5 μm or more, more preferably 10 μm or more, and still more preferably m or more.

Within this range, a difference from a particle size of the coating layer 31 can be secured, and the coating of the coating layer 31 becomes easy.

Furthermore, the oxide active substance 30 has a median diameter d50 of preferably 100 μm or less, more preferably 80 μm or less, still more preferably 50 μm or less, and particularly preferably 30 μm or less.

### <Coating Layer 31>

The coating layer 31 is configured of a lithium ion conductive oxide containing phosphorus as an element, and is preferably configured of a positive electrode active material that functions alone as a positive electrode active substance.

The lithium ion conductive oxide used in the coating layer 31 of the present embodiment is preferably a lithium phosphate-based lithium ion conductive oxide.

Examples of the lithium phosphate-based lithium ion conductive oxide are an inverse fluorite type, a NASICON type, a perovskite type, a garnet type, or an olivine type as a crystal structure, but are not particularly limited to.

As the lithium phosphate-based lithium ion conductive oxide, for example, a compound represented by Formula (a) described below (hereinafter, also referred to as LATP) can be used, and in particular, it is preferable to use Li₁₊ₚAlₚTi₂₋ₚP₃O₁₂ (satisfying 0≤p≤1):

Li_{1+p+q+r}AlₚGa_{q} (Ti, Ge)_{2-p-q}SiᵣP₃₋ᵣO₁₂ (a)
(Formula (a) described above satisfies 0<p≤1, 0≤q<1, and 0≤r≤1).

Furthermore, as the lithium phosphate-based lithium ion conductive oxide, for example, transition metal lithium phosphate having an olivine type crystal structure and represented by Formula (b) described below can be used, and in particular, LiFePO₄ is preferably used:

LiₐA_{b}D_{c}PO₄ (b)
(in Formula (b) described above, a, b, and c satisfy 0.9<a<1.1, 0<b≤1, 0≤c<1, and 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y).

Furthermore, the coating layer 31 may be configured of two or more kinds of lithium ion conductive oxides, or may be configured of a compound represented by Formula (a) described above and a compound represented by Formula (b) described above.

For example, in the case of being configured of LATP (compound represented by Formula (a)) and transition metal lithium phosphate (compound represented by Formula (b)), a ratio of LATP to the transition metal lithium phosphate is preferably 2/3 or more and 3/2 or less.

A particle size of the lithium ion conductive oxide constituting the coating layer 31 is preferably 10 nm or less, more preferably 8 nm or less, and still more preferably 6 nm or less in terms of a BET specific surface area equivalent diameter (dBET). Within this range, the surface of the oxide active substance 30 can be uniformly coated, and the dense coating layer 31 can be formed.

The particle size of the lithium ion conductive oxide constituting the coating layer 31 is preferably 10 nm or less as an average particle size calculated using an X-ray small angle scattering method.

Note that the BET specific surface area equivalent diameter (dBET) is a particle size by obtaining a nitrogen adsorption BET specific surface area by a nitrogen adsorption method single point method according to a method specified in JIS Z8830(2013), and determined by a formula of dBET=6/(density×BET specific surface area).

Assuming that the BET specific surface area equivalent diameter dBET of the lithium ion conductive oxide constituting the coating layer 31 is 1, the median diameter d50 of the oxide active substance 30 is preferably 100 or more and 10,000 or less, more preferably 300 or more and 5,000 or less, still more preferably 500 or more and 2,000 or less, and particularly preferably 1,000 or less.

Within this range, the coating of the oxide active substance 30 with the lithium ion conductive oxide is more dominant than the mutual aggregation of the lithium ion conductive oxides or the formation of aggregates of the oxide active substance 30 and the lithium ion conductive oxide, thus the lithium ion conductive oxide can easily coat the surface of the oxide active substance 30 to form the coating layer 31.

An amount of the coating layer 31 is preferably 0.5 parts by mass or more, more preferably 1 part by mass or more, and still more preferably 2 parts by mass or more with respect to 100 parts by mass of the oxide active substance 30.

Furthermore, the amount of the coating layer 31 is preferably 10 parts by mass or less, more preferably 5 parts by mass or less, and still more preferably 4 parts by mass or less with respect to 100 parts by mass of the oxide active substance 30.

The coating layer 31 constitutes a continuous layer that closely covers the surface shape of the oxide active substance 30.

A thickness of the coating layer 31 is preferably 5 nm or more and 50 nm or less, and more preferably 20 nm or less.

Within this range, it is possible to suppress the gas generation amount while suppressing the resistance loss in the coating layer 31.

In the coating layer 31, the grain boundary resistance is preferably 3 times or more, and more preferably 4 times or more larger than the charge transfer resistance of the oxide active substance 30.

In the coating layer 31, the grain boundary resistance is preferably 20 times or less, and more preferably 8 times or less larger than the charge transfer resistance of the oxide active substance 30.

Within these ranges, the arc attributed to the grain boundary resistance in impedance measurement hardly overlaps with that attributed to the charge transfer resistance of the oxide active substance 30, and is easily extracted as the grain boundary resistance.

The coating layer 31 preferably has a difference of 5% or less of grain boundary resistance from that of a coating layer 31, which is formed on the surface of the oxide active substance 30 by grinding a later describes fine particle fluid of the allowable limit amount t to the oxide active substance 30.

Within this range, it is possible to expect a gas generation suppressing effect that is not different from the case where the allowable limit amount is added.

The coating layer 31 preferably has a grain boundary resistance per unit weight of 0.2 Ω/g or more and 2 Ω/g or less.

### <Negative Electrode Active Material 21>

As the negative electrode active material 21, lithium titanate is preferably used from the viewpoint of hardly causing lithium deposition, thus, improving safety.

Among the lithium titanate, the negative electrode active material 21 is particularly preferably lithium titanate having a spinel structure from the viewpoint of small expansion and contraction of the active material in the reaction of insertion and desorption of lithium ions.

The lithium titanate may contain a trace amount of elements other than lithium and titanium, such as Nb, for example.

### <Conductive Aid>

The conductive aid is not particularly limited, but a carbon material is preferable.

The carbon material is preferably at least one selected from natural graphite, artificial graphite, vapor grown carbon fiber, carbon nanotube, acetylene black, ketjen black, and furnace black.

An amount of the conductive aid contained in the positive electrode 2 is preferably 1 part by weight or more and 30 parts by weight or less with respect to 100 parts by weight of the positive electrode composite active substance 20.

An amount of the conductive aid contained in the negative electrode 3 is preferably 1 part by weight or more and 30 parts by weight or less with respect to 100 parts by weight of the negative electrode active material 21.

Within the above range, the adhesiveness with the binder is maintained while the conductivity of the electrodes 2 and 3 is secured, and the adhesiveness with the current collectors 10 and 12 can be sufficiently obtained.

### <Binder>

The binder is not particularly limited, but for both the positive electrode 2 and the negative electrode 3, for example, at least one selected from the group consisting of polyvinylidene fluoride (PVdF), polytetrafluoroethylene (PTFE), styrene-butadiene rubber, polyimide, and derivatives thereof can be used.

The binder is preferably dissolved or dispersed in a nonaqueous solvent or water from the viewpoint of ease of preparation of the positive electrode 2 and the negative electrode 3.

The nonaqueous solvent is not particularly limited, and examples thereof include N-methyl-2-pyrrolidone (NMP), dimethylformamide, dimethylacetamide, methyl ethyl ketone, methyl acetate, ethyl acetate, and tetrahydrofuran. A dispersant and a thickener may be added thereto.

An amount of the binder contained in the positive electrode 2 is preferably 1 part by weight or more and 30 parts by weight or less with respect to 100 parts by weight of the positive electrode composite active substance 20.

An amount of the binder contained in the negative electrode 3 is preferably 1 part by weight or more and 30 parts by weight or less with respect to 100 parts by weight of the negative electrode active material 21.

Within the above range, the adhesiveness between the active substances 20 or the active materials 21 and the conductive agent is maintained, and the adhesiveness with the current collectors 10 and 12 can be sufficiently obtained.

### <Current Collectors 10 and 12>

The current collectors 10 and 12 are not particularly limited, but are preferably aluminum or an aluminum alloy since they are stable under a positive electrode reaction atmosphere or a negative electrode reaction atmosphere, and are more preferably high-purity aluminum represented by JIS standards 1030, 1050, 1085, 1N90, 1N99, and the like.

As the current collectors 10 and 12, it is also possible to use a metal other than aluminum (copper, SUS, nickel, titanium, and alloys thereof) of which surface is coated with a metal that does not react at the potential of the positive electrode 2 or the negative electrode 3.

### <Nonaqueous Electrolyte Solution 5>

The nonaqueous electrolyte solution 5 is not particularly limited, but a nonaqueous electrolyte solution in which a solute is dissolved in a nonaqueous solvent, a gel electrolyte that is a polymer impregnated with a nonaqueous electrolyte solution that is a solute dissolved nonaqueous solvent, or the like can be used.

The nonaqueous solvent preferably contains a cyclic aprotic solvent and/or a chain aprotic solvent.

Examples of the cyclic aprotic solvent include cyclic carbonate, cyclic ester, cyclic sulfone, and cyclic ether.

As the chain aprotic solvent, a solvent generally used as a solvent of a nonaqueous electrolyte, such as a chain carbonate, a chain carboxylic acid ester, a chain ether, or acetonitrile, may be used.

More specifically, as the aprotic solvent, dimethyl carbonate, methyl ethyl carbonate, diethyl carbonate, dipropyl carbonate, methyl propyl carbonate, ethylene carbonate, propylene carbonate, butylene carbonate, γ-butyllactone, 1,2-dimethoxyethane, sulfolane, dioxolane, methyl propionate, and the like can be used.

These solvents may be used singly or in combination of two or more kinds thereof, but it is preferable to use a mixture of two or more kinds thereof from the viewpoint of ease of solute dissolution and high lithium ion conductivity described later.

In a case where two or more kinds are mixed as the aprotic solvent, one or more kinds among chain carbonates exemplified by dimethyl carbonate, methylethyl carbonate, diethyl carbonate, dipropyl carbonate, and methylpropyl carbonate and one or more kinds among cyclic compounds exemplified by ethylene carbonate, propylene carbonate, butylene carbonate, and y-butyllactone are preferably mixed because of high stability at high temperatures and high lithium conductivity at low temperatures.

It is particularly preferable to mix one or more of chain carbonates exemplified by dimethyl carbonate, methylethyl carbonate, and diethyl carbonate with one or more of cyclic carbonates exemplified by ethylene carbonate, propylene carbonate, and butylene carbonate.

The solute used in the nonaqueous electrolyte solution 5 is not particularly limited, but for example, LiClO₄, LiBF₄, LiPF₆, LiAsF₆, LiCF₃SO₃, LiBOB (Lithium Bis (Oxalato) Borate), LiN(SO₂CF₃)₂, and the like are preferable because they are easily dissolved in a solvent.

The nonaqueous electrolyte solution 5 may further contain a vinyl group-containing cyclic siloxane such as 2,4,6,8-tetravinyl-2,4,6,8-tetramethylcyclotetrasiloxane (4VC4S) as an additive.

The nonaqueous electrolyte solution 5 may be contained in the positive electrode 2, the negative electrode 3, and the separator 6 in advance, or may be added after the separator 6 disposed between a side of the positive electrode 2 and a side of the negative electrode 3 is wound or laminated.

### <Separator 6>

The separator 6 may have any structure that is provided between the positive electrode 2 and the negative electrode 3, is insulating, and can contain the nonaqueous electrolyte solution 5.

Examples of the separator 6 are a woven fabric, a nonwoven fabric, or a microporous membrane, etc. of nylon, cellulose, polysulfone, polyethylene, polypropylene, polybutene, polyacrylonitrile, polyimide, polyamide, polyethylene terephthalate, polyvinyl alcohol, and a composite of two or more thereof.

The separator 6 may contain various plasticizers, antioxidants, and flame retardants, or may be coated with a metal oxide or the like.

Subsequently, a production method for the lithium ion secondary battery 1 of the present embodiment will be described.

The production method for the lithium ion secondary battery 1 of the present embodiment is mainly configured by an active substance forming step of forming the positive electrode composite active substance 20, a positive electrode forming step of forming the positive electrode 2, a negative electrode forming step of forming the negative electrode 3, and a secondary battery assembling step of assembling the positive electrode 2, the negative electrode 3, and the nonaqueous electrolyte solution 5, and the negative electrode forming step and the secondary battery assembling step are the same as the conventional steps, and thus the description thereof is omitted.

Furthermore, in the production method for the lithium ion secondary battery 1 of the present embodiment, a measurement step of measuring the grain boundary resistance of the positive electrode 2 and a determination step of determining quality are performed after the secondary battery assembling step as necessary.

In the active substance forming step, first, the lithium ion conductive oxide is pulverized by a pulverizer such as a ball mill to form lithium ion conductive oxide particles (pulverization step).

At this time, the lithium ion conductive oxide is a lithium ion conductive oxide containing phosphorus similar to the coating layer 31 described above, and can be selected from the same material as the coating layer 31 described above.

An average particle size of the lithium ion conductive oxide at this time is not particularly limited.

For example, in the case of LATP, the average particle size of the lithium ion conductive oxide is preferably more than 0 nm and 10 nm or less.

Within this range, the crystal structure is partially broken, the whole or part can be made amorphous (non-crystalline), and a dense layer can be formed.

Furthermore, the average particle size of the lithium ion conductive oxide is preferably 20 nm or more and 100 nm or less, for example, in the case of transition metal lithium phosphate.

Within this range, peeling off due to aggregation in a ground product forming step can be suppressed.

Subsequently, the lithium ion conductive oxide particles pulverized and micronized in the pulverization step are dispersed in a dispersion solvent to form a fine particle fluid (fine particle fluid forming step).

The dispersion solvent used at this time is preferably one or more alcohol solutions, and more preferably ethanol from the viewpoint of volatility and safety.

The fine particle fluid formed at this time is a transparent sol in a sol state and is an electrolyte sol having fluidity.

Subsequently, the coating layer 31 is formed on the surface of the oxide active substance 30 by a mechanical coating method in which the oxide active substance 30 and the lithium ion conductive oxide in the fine particle fluid are brought into mechanical contact with each other while applying at least one energy of a shear force, a compressive force, a collision force, and a centrifugal force to the oxide active substance 30 and/or the lithium ion conductive oxide constituting the coating layer 31.

In the present embodiment, the fine particle fluid is ground onto the oxide active substance 30 by a grinding device such as a grinding mill to form a ground product (a ground product forming step).

A treatment temperature in the grinding device at this time is preferably 5° C. or more and 130° C. or less, more preferably 8° C. or more and 80° C. or less, and still more preferably 10° C. or more and 50° C. or less.

The treatment time in the grinding device at this time is preferably 5 minutes or more and 90 minutes or less, and more preferably 10 minutes or more and 60 minutes or less.

An atmosphere in the grinding device at this time is preferably an inert gas atmosphere or an air atmosphere.

At this time, the ground product is preferably formed by grinding the fine particle fluid in an amount of 50% or less of the allowable limit amount with respect to the oxide active substance 30.

Subsequently, the ground product is subjected to a heat treatment to remove the dispersion solvent from the ground product, thereby forming the positive electrode composite active substance 20 (removal step).

A heat treatment temperature at this time is preferably higher than 50° C., more preferably 100° C. or higher, still more preferably 300° C. or higher, and particularly preferably 350° C. or higher.

When the heat treatment temperature is lower than 50° C., adhesion between the oxide active substance 30 and the coating layer 31 is insufficient, so that the coating layer 31 may be peeled off during charging and discharging of the battery, leading to deterioration of long-term reliability of the battery.

On the other hand, when the heat treatment temperature becomes too high, the crystal structure of the coating layer 31 changes, and the Li ion conductivity decreases, so that charging and discharging of the battery may not be performed normally. Therefore, the heat treatment temperature is preferably 650° C. or lower, more preferably lower than 600° C., and still more preferably 500° C. or lower from the viewpoint of suppressing crystallization of the coating layer 31.

The heat treatment time is preferably 30 minutes or more, and more preferably 1 hour or more. An upper limit of the heat treatment time is not particularly limited, but is, for example, 3 hours or less.

The above is the active substance forming step.

When the active substance forming step is completed, the process proceeds to the positive electrode forming step.

In the positive electrode forming step, first, the positive electrode composite active substance 20 obtained in the active substance forming step is mixed with a conductive aid and a binder to prepare a positive electrode mixture, and the positive electrode mixture is applied to the positive electrode current collector 10 (positive electrode applying step).

Subsequently, the positive electrode current collector 10 coated with the positive electrode mixture is dried to form the positive electrode 2 (positive electrode drying step).

The positive electrode 2 formed in the positive electrode forming step described above is assembled together with the negative electrode 3 formed in the negative electrode forming step and the nonaqueous electrolyte solution 5 in the same manner as in the prior art, thereby completing the lithium ion secondary battery 1.

For the lithium ion secondary battery 1 formed by the above steps, AC impedance measurement is performed as necessary, and the grain boundary resistance of the coating layer 31 in the positive electrode 2 is measured (measurement step).

Then, it is confirmed whether the grain boundary resistance of the coating layer 31 falls within a predetermined range, and in a case where the grain boundary resistance falls within the predetermined range, the lithium ion secondary battery 1 is determined to be a non-defective product. In a case of not falling within the predetermined range, it is determined that the lithium ion secondary battery 1 is a defective product(determination step).

The predetermined range at this time is preferably a range in which the grain boundary resistance of the coating layer 31 is 3 times or more and 20 times or less larger than the charge transfer resistance of the oxide active substance 30.

As measurement conditions at this time, an AC impedance is measured at a frequency of 0.1 Hz to 10 kHz and an amplitude of 10 mV in a state where the lithium ion secondary battery 1 is charged to a charge depth of 50%, and a Nyquist plot is calculated. The charge transfer resistance and the grain boundary resistance are calculated from two arcs obtained from the Nyquist plot.

The term “Nyquist plot” as used herein refers to a so-called Cole-Cole plot, which is a graph obtained by measuring the resistance and reactance of an object to be measured at different frequencies and plotting the resistance on a horizontal axis and the reactance on a vertical axis. That is, it is a graph in which the AC impedance is plotted with the vertical axis as a real component and the horizontal axis as an imaginary component.

The calculation method of the charge transfer resistance and the grain boundary resistance from the Nyquist plot is not particularly limited, but they can be separately calculated, for example, by performing fitting using an equivalent circuit in which at least two or more RC parallel circuits are connected in series.

Note that the non-defective/defective criterion may be falling within/out 5% of the difference between the grain boundary resistance of the coating layer 31 and a grain boundary resistance of the coating layer 31 when the coating layer 31 is formed on the surface of the oxide active substance 30 by grinding the fine particle fluid of the allowable limit amount to the oxide active substance 30.

According to the positive electrode composite active substance 20 of the present embodiment, since the coating layer 31 uniformly covers the oxide active substance 30, an area in contact with the nonaqueous electrolyte solution 5 is reduced, and gas generation can be suppressed. Furthermore, even in a case where the nonaqueous electrolyte solution 5 or the additive is partially decomposed, the decomposition product can fill a gap of the coating of the coating layer 31 and form a good coating film, so that further decomposition of the nonaqueous electrolyte solution 5 can be suppressed.

According to the positive electrode composite active substance 20 of the present embodiment, since the grain boundary resistance of the coating layer 31 is 3 times or more and 20 times or less larger than the charge transfer resistance of the oxide active substance 30, it is also possible to suppress the resistance loss due to the resistance of the coating layer 31 while suppressing the generation of gas due to the decomposition of the nonaqueous electrolyte solution 5 as compared with the conventional case.

According to the positive electrode composite active substance 20 of the present embodiment, in the coating layer 31, the grain boundary resistance per unit weight is 0.2 Ω/g or more and 2 Ω/g or less, and the grain boundary resistance is small, so that the resistance loss can be suppressed.

According to the lithium ion secondary battery 1 of the present embodiment, when the AC impedance measurement is performed in a state of being charged to a depth of charge of 50% and a Nyquist plot is calculated at a frequency of 0.1 Hz to 10 kHz and an amplitude of 10 mV, at least two arcs are calculated, and a diameter of the arc on a low frequency component side among the two arcs is 3 times or more and 20 times or less larger than a diameter of an arc on a high frequency component side. Therefore, as compared with the related art, it is possible to suppress the resistance loss due to the resistance of the coating layer 31 while suppressing the generation of gas due to the decomposition of the nonaqueous electrolyte solution 5.

According to the production method for the lithium ion secondary battery 1 of the present embodiment, the gas generation amount can be predicted by the grain boundary resistance of the coating layer 31 of the positive electrode 2, and the quality can be determined, so that the yield can be improved.

According to the lithium ion secondary battery 1 of the present embodiment, the difference between the grain boundary resistance of the coating layer 31 and a grain boundary resistance of the coating layer 31 that is formed on the surface of the oxide active substance 30 by grinding the fine particle fluid of the allowable limit amount to the oxide active substance 30 is within 5%, and the coating layer 31 is formed by grinding the fine particle fluid in an amount of 50% or less of the allowable limit amount to the oxide active substance 30.

That is, based on the case where the coating layer 31 is formed with the allowable limit amount of the oxide active substance 30, in the lithium ion secondary battery 1 of the present embodiment, the grain boundary resistance of the coating layer 31 is within 5%, and the coating layer 31 is formed of a fine particle fluid in an amount of 50% or less of the allowable limit amount of the oxide active substance 30.

Therefore, it is possible to suppress the gas generation without adding the fine particle fluid to the oxide active substance 30 in an amount more than or equal to the allowable limit amount, and it is possible to suppress the resistance loss due to the coating layer 31 while suppressing the gas generation due to the decomposition of the nonaqueous electrolyte solution 5 as compared with the conventional case. Furthermore, since the fine particle fluid to be used can be reduced, the cost can be reduced.

In the embodiment described above, the grain boundary resistance of the coating layer 31 in the positive electrode 2 is measured after the lithium ion secondary battery 1 is completed, but the present invention is not limited thereto. After the positive electrode 2 is formed in the positive electrode forming step, the measurement step of measuring the grain boundary resistance of the coating layer 31 in the positive electrode 2 may be executed to determine the quality of the positive electrode 2.

In the embodiment described above, each component member can be freely replaced or added between the embodiments as long as it is included in the technical scope of the present invention.

### EXAMPLES

Hereinafter, the present invention will be specifically described by way of experimental examples. Note that the present invention is not limited to the following experimental examples, and can be appropriately modified without changing the gist thereof.

### Experimental Examples 1 and 2

### (i) Production of Positive Electrode

First, as a lithium ion conductive oxide, Li_{1.3}Al_{0.3}Ti_{1.7}(PO₄)₃ (hereinafter, also referred to as LATP) was prepared. As starting materials, Li₂CO₃, AlPO₄, TiO₂, NH₄H₂PO₄, and ethanol as a solvent were mixed in predetermined amounts, and a planetary ball mill treatment was performed at 150 G for 3 hours using zirconia spheres having a diameter of 3 mm. The zirconia spheres were removed from the treated mixture with a sieve and then dried at 120° C. to remove ethanol. Thereafter, treatment was performed at 800° C. for 2 hours to obtain a LATP powder.

A predetermined amount of ethanol as a solvent was mixed with the obtained LATP powder, and a planetary ball mill treatment was performed for 1 to 3 hours using zirconia spheres having a diameter of 0.5 mm. The zirconia spheres were removed from the treated mixture with a sieve and then dried at 120° C. to remove ethanol. As a result, a LATP fine powder having dBET of 10 nm or less was obtained. Next, the LATP fine powder and ethanol were mixed to obtain a slurry (fine particle fluid) in which the LATP fine powder was dispersed in 16.4 wt % ethanol.

As an active material of the positive electrode, spinel type nickel manganate lithium (LiNi_{0.5}Mn_{1.5}O₄, hereinafter, also referred to as LNMO) having a median diameter of 20 μm was used.

40 g of LNMO was charged into a grinding mill (manufactured by Hosokawa Micron Corporation, product name: NOBILTA), and while rotating the mill at a clearance of 0.6 mm, a rotor load power of 1.5 kW, and 2,600 rpm, the ethanol-dispersed slurry of the LATP fine powder was charged twice so that an addition amount of the LATP fine powder was 1.2 wt %. Thereafter, the rotor rotation speed was maintained in a range of 2,600 rpm to 3,000 rpm, and treatment was performed at room temperature for 10 minutes under an air atmosphere to obtain LNMO with the surface coated with LATP. The obtained surface-coated LNMO was heat-treated at 350° C. for 1 hour to obtain a positive electrode composite active substance.

A slurry was prepared by dispersing a mixture containing the obtained positive electrode composite active substance, acetylene black as a conductive aid, and polyvinylidene fluoride (PVdF) as a binder in a solid concentration of 90 parts by weight, 6 parts by weight, and 4 parts by weight, respectively, in N-methyl-2-pyrrolidone (NMP). Note that the binder was adjusted to an N-methyl-2-pyrrolidone (NMP) solution having a solid concentration of 5% by weight, and NMP was further added to adjust the viscosity so as to facilitate the coating described later.

The slurry was applied to a 20 μmt aluminum foil, and then dried in an oven at 120° C. This operation was performed on both surfaces of the aluminum foil, and the aluminum foil was further vacuum-dried at 170° C. to produce a positive electrode.

### (ii) Production of Negative Electrode

As a negative electrode active material, spinel type lithium titanate (Li₄Ti₅O₁₂, hereinafter, also referred to as LTO) was used. A slurry was prepared by dispersing a mixture containing the LTO, acetylene black as a conductive aid, and polyvinylidene fluoride (PVdF) as a binder in a solid concentration of 100 parts by weight, 5 parts by weight, and 5 parts by weight, respectively, in N-methyl-2-pyrrolidone (NMP). Note that the binder was prepared in an NMP solution having a solid content concentration of 5% by weight, and NMP was further added to adjust the viscosity so as to facilitate the coating described later.

The slurry was applied to a 20 μmt aluminum foil, and then dried in an oven at 120° C. This operation was performed on both surfaces of the aluminum foil, and then vacuum drying was further performed at 170° C. to produce a negative electrode.

(iii) Production of Lithium Ion Secondary Battery

A battery was produced by the following procedure using the positive electrode and the negative electrode produced in the above (i) and (ii) and a 20 μmt polypropylene separator.

First, the positive electrode and the negative electrode were dried under reduced pressure at 80° C. for 12 hours. Next, 15 positive electrodes and 16 negative electrodes were used and laminated in the order of negative electrode/separator/positive electrode. Both outermost layers were made to be separators. Next, aluminum tabs were vibration-welded to the positive electrode and the negative electrode at both ends.

Two aluminum laminate films as exterior materials were prepared, and after forming a depression to be a battery part and a depression to be a gas collecting part by pressing, the electrode laminate was placed.

An outer circumferential portion leaving a space for nonaqueous electrolyte injection was heat-sealed at 180° C. for 7 seconds, a nonaqueous electrolyte obtained by dissolving LiPF₆ at a rate of 1 mol/L in a solvent obtained by mixing ethylene carbonate, propylene carbonate, and ethyl methyl carbonate at a ratio of ethylene carbonate/propylene carbonate/ethyl methyl carbonate=15/15/70 on a volume basis was added from an unsealed portion, and then the unsealed portion was heat-sealed at 180° C. for 7 seconds while reducing the pressure.

The obtained battery was subjected to constant current charging at a current value corresponding to 0.2 C until the battery voltage reached an end voltage of 3.4 V, and charging was stopped. Thereafter, the battery was allowed to stand in an environment of 60° C. for 24 hours, and then discharged at a constant current at a current value corresponding to 0.2 C, and the discharge was stopped when the battery voltage reached 2.5 V. After the discharge was stopped, the gas accumulated in the gas collecting part was removed, and resealing was performed. Two lithium ion secondary batteries for evaluation were produced by the above operation, and used as Experimental Examples 1 and 2, respectively.

### Experimental Examples 3 to 6

Four lithium ion secondary batteries for evaluation were produced in the same manner as in Experimental Examples 1 and 2 except that in (i) Production of positive electrode, the amount of LATP added to LNMO was adjusted to 2.4 wt %, and were designated as Experimental Examples 3 to 6.

### Experimental Examples 7 and 8

Two lithium ion secondary batteries for evaluation were prepared as Experimental Examples 7 and 8 in the same manner as in Experimental Examples 1 and 2 except that in (i) Production of positive electrode, the amount of LATP added to LNMO was adjusted to 3.6 wt %.

### Experimental Examples 9 and 10

### (iv) Production of Positive Electrode

First, a predetermined amount of ethanol as a solvent was mixed with a lithium iron phosphate (LiFePO₄, hereinafter also referred to as LFP) powder having a surface area of 9.5 m²/g and a median diameter of 1.5 μm, and a planetary ball mill treatment was performed for 3 hours using zirconia spheres having a diameter of 0.5 mm. The zirconia spheres were removed from the treated mixture with a sieve and then dried at 120° C. to remove ethanol. This gave an LFP fine powder having a BET value (BET surface area) of 20 m²/g to 80 m²/g. Next, the LFP fine powder and ethanol were mixed to obtain a slurry (fine particle fluid) in which the LFP fine powder was dispersed in ethanol having a solid content of 16.4 wt %.

30 g of LNMO was charged into a grinding mill, and while rotating the mill at a clearance of 0.6 mm, a rotor load power of 1.5 kW, and 2,600 rpm, the ethanol-dispersed slurry of the LFP fine powder was charged twice so that the addition amount of the LFP fine powder was 2.4 wt %. Thereafter, the rotor rotation speed was maintained in a range of 2,600 rpm to 3,000 rpm, and treatment was performed at room temperature for 10 minutes under an air atmosphere to obtain LNMO with the surface coated with LFP. The obtained surface-coated LNMO was heat-treated at 350° C. for 1 hour to obtain a positive electrode composite active substance.

A slurry was prepared by dispersing a mixture containing the obtained positive electrode composite active substance, acetylene black as a conductive aid, and polyvinylidene fluoride (PVdF) as a binder in a solid concentration of 90 parts by weight, 6 parts by weight, and 4 parts by weight, respectively, in N-methyl-2-pyrrolidone (NMP). Note that the binder was adjusted to an N-methyl-2-pyrrolidone (NMP) solution having a solid concentration of 5% by weight, and NMP was further added to adjust the viscosity so as to facilitate the coating described later.

The slurry was applied to a 20 μmt aluminum foil, and then dried in an oven at 120° C. This operation was performed on both surfaces of the aluminum foil, and the aluminum foil was further vacuum-dried at 170° C. to produce a positive electrode.

Thereafter, (ii) Production of negative electrode and (iii) Production of lithium ion secondary battery were performed in the same manner as in Experimental Examples 1 and 2 to produce two lithium ion secondary batteries for evaluation, and these batteries were designated as Experimental Examples 9 and 10, respectively.

### Experimental Example 11

A lithium ion secondary battery for evaluation was produced as Experimental Example 11 in the same manner as in Experimental Examples 9 and 10 except that the addition amount of LFP to LNMO was adjusted to 3.6 wt % in (iv) Production of positive electrode.

### Experimental Examples 12 and 13

### (v) Production of Positive Electrode

30 g of LNMO was charged into a grinding mill, and while rotating at a clearance of 0.6 mm, a rotor load power of 1.5 kW, and 2,600 rpm, an ethanol-dispersed slurry in which LATP fine powder and LFP fine powder were mixed at a ratio of 1:1 was charged twice so that an addition amount of the LATP fine powder and the LFP fine powder was 2.4 wt %. Thereafter, the rotor rotation speed was maintained in a range of 2,600 rpm to 3,000 rpm, and treatment was performed at room temperature for 10 minutes under an air atmosphere to obtain LNMO with the surface coated with LATP and LFP. The obtained surface-coated LNMO was heat-treated at 350° C. for 1 hour to obtain a positive electrode composite active substance.

A slurry was prepared by dispersing a mixture containing the obtained positive electrode composite active substance, acetylene black as a conductive aid, and polyvinylidene fluoride (PVdF) as a binder in a solid concentration of 90 parts by weight, 6 parts by weight, and 4 parts by weight, respectively, in N-methyl-2-pyrrolidone (NMP). Note that the binder was adjusted to an N-methyl-2-pyrrolidone (NMP) solution having a solid concentration of 5% by weight, and NMP was further added to adjust the viscosity so as to facilitate the coating described later.

The slurry was applied to a 20 μmt aluminum foil, and then dried in an oven at 120° C. This operation was performed on both surfaces of the aluminum foil, and the aluminum foil was further vacuum-dried at 170° C. to produce a positive electrode.

Thereafter, (ii) Production of negative electrode and (iii) Production of lithium ion secondary battery were performed in the same manner as in Experimental Examples 1 and 2 to prepare two lithium ion secondary batteries for evaluation, and these batteries were designated as Experimental Examples 12 and 13, respectively.

### Experimental Example 14

(i) This example was designated as Experimental Example 14 in the same manner as in Experimental Examples 1 and 2 except that LNMO was used as it was without adding LATP to LNMO in the production of the positive electrode.

### (Measurement of Gas Generation Amount)

The evaluation of the gas generation amount of the lithium ion secondary battery before and after the cycle characteristics evaluation in each of Experimental Examples 1 to 14 was evaluated using the Archimedes method, that is, the buoyancy of the lithium ion secondary battery. The evaluation was performed as follows.

First, the weight of the lithium ion secondary battery was measured with an electronic balance. Next, the weight in water was measured using a pycnometer (manufactured by Alpha Mirage Co., Ltd., product number: MDS-3000), and the buoyancy was calculated by taking a difference between these weights. A volume of the lithium ion secondary battery was calculated by dividing the buoyancy by the density of water (1.0 g/cm³).

Subsequently, the lithium ion secondary battery was connected to a charge/discharge device (HJ1005SD8, manufactured by HOKUTO DENKO CORPORATION), and a cycle operation was performed. Under an environment of 60° C., constant current charging was performed at a current value corresponding to 1.0 C until the battery voltage reached a final voltage of 3.4 V, and charging was stopped. Subsequently, constant current discharge was performed at a current value corresponding to 1.0 C, and the discharge was stopped when the battery voltage reached 2.5 V. Charging and discharging were repeated with this as one cycle.

An amount of gas generated was calculated by comparing a volume after aging with a volume after 400 cycles.

### (AC Impedance Measurement)

The AC impedance measurement was performed by applying an AC wave having a voltage amplitude of 10 mV and a frequency of 0.1 Hz to 10 kHz to a lithium ion secondary battery charged to a charge depth of 50% using a potentiostat and a frequency response analyzer manufactured by Solartron. Furthermore, the Nyquist plot obtained by the AC impedance measurement was fitted using an equivalent circuit, and the series resistance, the charge transfer resistance in the positive electrode composite active substance, and the grain boundary resistance in the coating layer were evaluated.

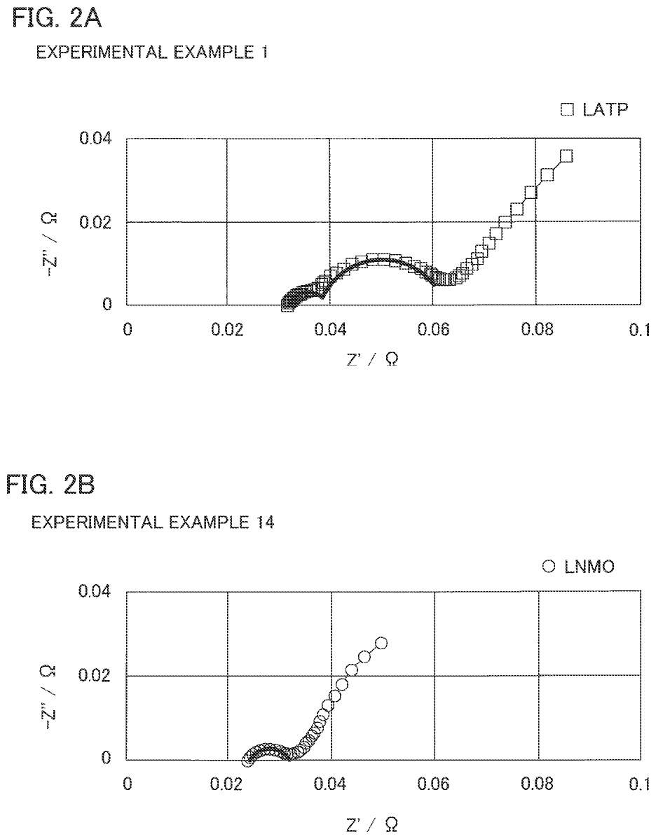

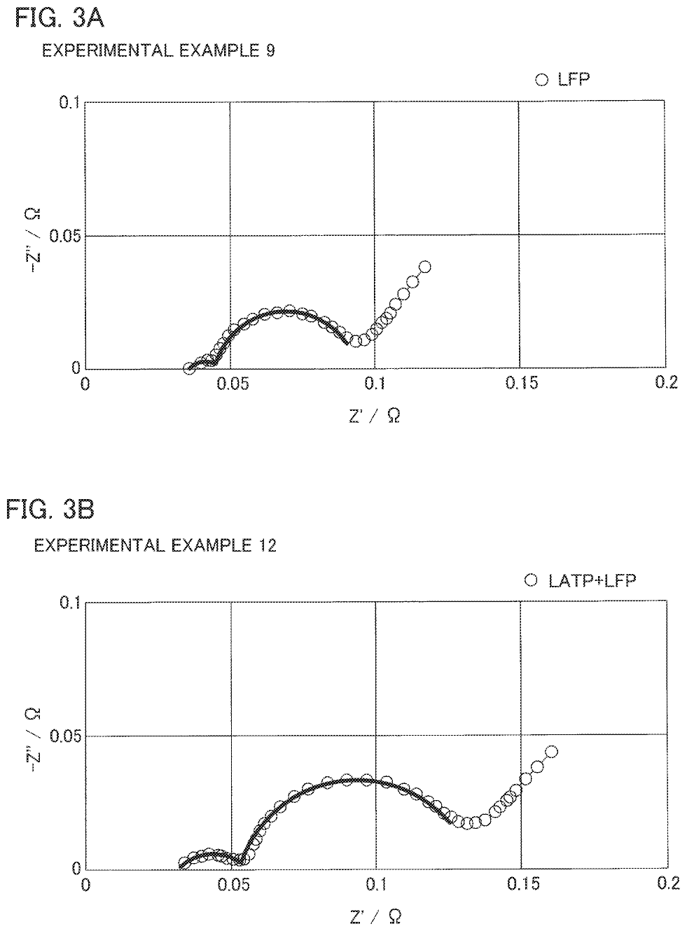

The results of gas generation amount measurement, initial capacity, and AC impedance measurement of Experimental Examples 1 to 14 are shown in FIGS. 2A, 2B, 3A, and 3B, and Table 1.

TABLE 1
TABLE 1

| | | | | | | Ratio:GRAIN |
|---|---|---|---|---|---|---|
| | | | GRAIN | | GAS | BOUNDARY |
| | | COATING | BOUNDARY | INITIAL | GENERATION | RESISTANCE/CHARGE |
| | COATING | AMOUNT | RESISTANCE | CAPACITY | AMOUNT | TRANSFER |
| | MATERIAL | (WEIGHT %) | (Ω) | (mAh/g) | (cm³) | RESISTANCE |
| EXPERIMENTAL | LATP | 1.2 | 0.0257 | 103.3 | 7.788 | 4.5 |
| EXAMPLE 1 | | | | | | |
| EXPERIMENTAL | LATP | 1.2 | 0.0234 | 103.6 | 7.995 | 3.0 |
| EXAMPLE 2 | | | | | | |
| EXPERIMENTAL | LATP | 2.4 | 0.135 | 76.3 | 4.506 | 19.0 |
| EXAMPLE 3 | | | | | | |
| EXPERIMENTAL | LATP | 2.4 | 0.1344 | 75.8 | 4.351 | 16.2 |
| EXAMPLE 4 | | | | | | |
| EXPERIMENTAL | LATP | 2.4 | 0.0239 | 97.7 | 7.221 | 3.5 |
| EXAMPLE 5 | | | | | | |
| EXPERIMENTAL | LATP | 2.4 | 0.0261 | 98.4 | 6.8 | 4.3 |
| EXAMPLE 6 | | | | | | |
| EXPERIMENTAL | LATP | 3.6 | 0.0391 | 94.1 | 8.106 | 6.0 |
| EXAMPLE 7 | | | | | | |
| EXPERIMENTAL | LATP | 3.6 | 0.0344 | 94.9 | 8.709 | 5.0 |
| EXAMPLE 8 | | | | | | |
| EXPERIMENTAL | LFP | 2.4 | 0.051 | 85.3 | 4.1173 | 7.0 |
| EXAMPLE 9 | | | | | | |
| EXPERIMENTAL | LFP | 2.4 | 0.05 | 92 | 5.1535 | 7.4 |
| EXAMPLE 10 | | | | | | |
| EXPERIMENTAL | LFP | 3.6 | 0.069 | 81.3 | 4.8 | 7.9 |
| EXAMPLE 11 | | | | | | |
| EXPERIMENTAL | LATP + | 2.4 | 0.079 | 81.4 | 3.918 | 5.0 |
| EXAMPLE 12 | LFP | | | | | |
| EXPERIMENTAL | LATP + | 2.4 | 0.075 | 80.1 | 4.289 | 15.0 |
| EXAMPLE 13 | LFP | | | | | |
| EXPERIMENTAL | — | — | — | 116.2 | 22.972 | — |
| EXAMPLE 14 | | | | | | |

In Experimental Example 14 in which the coating layer was not formed, one arc was observed in the Nyquist plot as illustrated in FIG. 2B, whereas in Experimental Example 1 in which the coating layer configured of LATP was formed, two arcs were observed in the Nyquist plot as illustrated in FIG. 2A.

Furthermore, also in Experimental Example 9 in which the coating layer configured of LFP was formed (FIG. 3A) and Experimental Example 12 in which the coating layer configured of LATP and LFP was formed (FIG. 3B), two arcs were observed in the Nyquist plot.

When Experimental Example 1 (FIG. 2A) and Experimental Example 14 (FIG. 2B) are compared, a size of the arc on a high frequency side is the same, and a new arc appears on a low frequency side by coating the coating layer. Therefore, it is considered that the resistance generated by the formation of the coating layer, that is, the grain boundary resistance and the capacitance are detected for the arc on the low frequency side.

In Experimental Examples 1 to 13, the grain boundary resistance with respect to the charge transfer resistance of LNMO was 3 times or more and 20 times or less larger, and the gas generation amount was a small value as compared with that in Experimental Example 14.

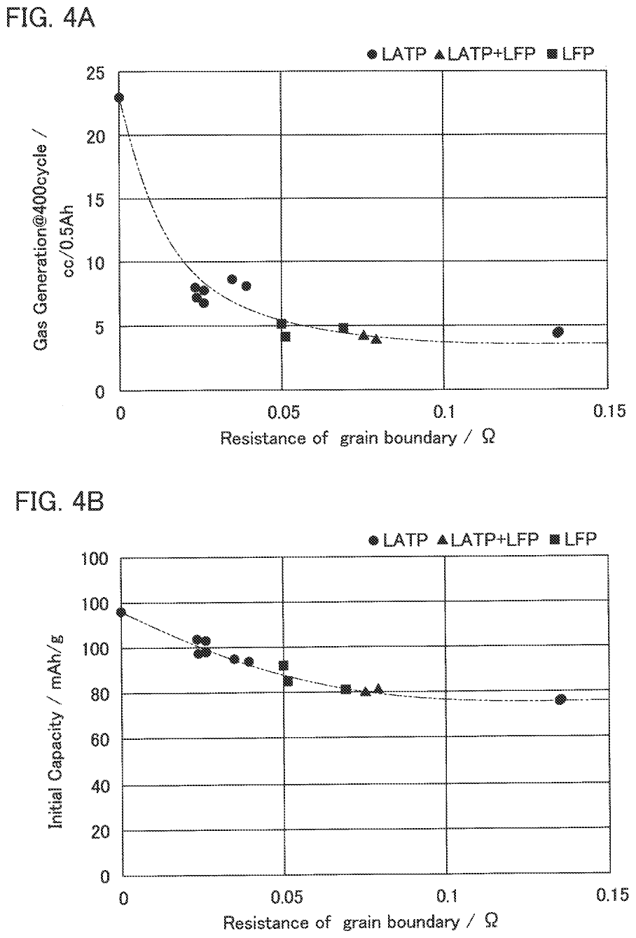

FIG. 4A illustrates a relationship between the grain boundary resistance and the gas generation amount in Experimental Examples 1 to 14, and FIG. 4B illustrates a relationship between the grain boundary resistance and the initial capacity in Experimental Examples 1 to 14.

In the lithium ion secondary batteries of Experimental Examples 1 to 14, as illustrated in FIGS. 4A and 4B, a high correlation was illustrated between the grain boundary resistance and the gas generation amount and between the grain boundary resistance and the initial capacity, and it was found that as the grain boundary resistance increased, the gas generation amount decreased and the initial capacity decreased.

That is, it was found that in FIG. 4A, the grain boundary resistance and the gas generation amount corresponded approximately 1:1, and in FIG. 4B, the grain boundary resistance and the initial capacity corresponded approximately 1:1.

From this result, it was suggested that in the lithium ion secondary battery using the positive electrode composite active substance, it is possible to roughly predict the gas generation amount and the initial capacity by measuring the grain boundary resistance value of the coating layer. In other words, it was suggested that the performance of the lithium ion secondary battery can be evaluated and the yield can be reduced by performing the AC impedance measurement, which is a non-destructive inspection, on the completed product of the lithium ion secondary battery and measuring the grain boundary resistance.

When Experimental Examples 3 to 6 were compared, the value of the grain boundary resistance varied even though they were formed under the same conditions. That is, while the grain boundary resistances of Experimental Examples 5 and 6 were 0.024 to 0.026, the grain boundary resistances of Experimental Examples 3 and 4 were as large as 0.134 to 0.135.

From this, it was suggested that in a case where LATP was coated, formation of the coating layer was unstable.

Here, it is generally considered that as the addition amount of the lithium ion conductive oxide (LATP) is increased, the thickness of the coating layer is increased and the grain boundary resistance is increased, but in Experimental Examples 5 and 6, the grain boundary resistance is almost the same as that in Experimental Example 2 in which the addition amount of the lithium ion conductive oxide is small, and in Experimental Examples 3 and 4, the grain boundary resistance is larger than that in Experimental Example 2, and is larger than that in Experimental Examples 7 and 8.

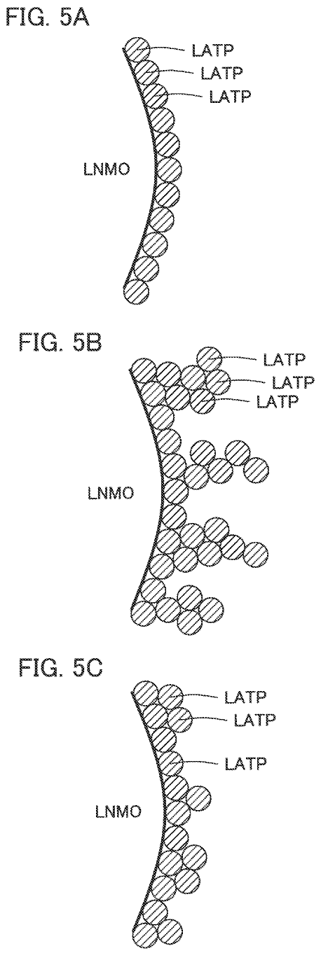

This is considered to be because in Experimental Examples 3 to 6 with the addition amount of 2.4 wt %, the addition amount of the lithium ion conductive oxide increases as illustrated in FIGS. 5A to 5B, the addition amount of the lithium ion conductive oxide becomes around the allowable limit amount as illustrated in FIG. 5B, and the coating of LATP on the surface of LNMO becomes unstable.

Therefore, in Experimental Examples 3 and 4, the lithium ion conductive oxide on the surface was not peeled off in the state of FIG. 5B, and the state in which the coating layer was thick was maintained, whereas in Experimental Examples 5 and 6, it is considered that the lithium ion conductive oxide on the surface was peeled off as in the change from FIG. 5B to FIG. 5C, and the thickness of the coating layer was reduced to the same extent as in Experimental Examples 1 and 2. As a result, it is considered that in Experimental Examples 3 and 4 in which the coating layer was thick, the grain boundary resistance was large, and in Experimental Examples 5 and 6 in which a part of the coating layer was peeled off, the grain boundary resistance was small.

From the above results, it was found that the gas generation amount was reduced by coating LNMO with the coating layer. Furthermore, it was found that when LNMO was coated with the coating layer, an arc corresponding to the grain boundary resistance of the coating layer appeared in the impedance plot, and a high correlation was shown between the grain boundary resistance and the gas generation amount and between the grain boundary resistance and the initial capacity.

It was suggested that the amount of gas generation that could occur in the future could be predicted by measuring the grain boundary resistance.

It was suggested that when nano-sized LATP was coated beyond the allowable limit amount, the coating layer was formed in a staggered manner and became a uniform layer after the coating layer was peeled off.

It was found that by using the grain boundary resistance of the coating layer added in excess of the allowable limit amount as a reference, a coating layer having the same quality as the allowable limit amount can be constantly formed.

### REFERENCE CHARACTER LIST

1: Lithium ion secondary battery
2: Positive electrode
3: Negative electrode
5: Nonaqueous electrolyte solution
10: Positive electrode current collector
11: Positive electrode composite active substance layer
20: Positive electrode composite active substance
21: Negative electrode active material
30: Oxide active substance
31: Coating layer

1. A positive electrode composite active substance constituting a part of a positive electrode of a lithium ion secondary battery using a nonaqueous electrolyte solution as an electrolyte, the positive electrode composite active substance comprising:
an oxide active substance; and
a coating layer covering a surface of the oxide active substance,
wherein the coating layer has lithium ion conductivity, and
a grain boundary resistance of the coating layer is 3 times or more and 20 times or less larger than a charge transfer resistance of the oxide active substance.

2. The positive electrode composite active substance according to claim 1, wherein the coating layer has a grain boundary resistance per unit weight of 0.2 Ω/g or more and 2 Ω/g or less.

3. The positive electrode composite active substance according to claim 1, wherein the coating layer has a thickness of 5 nm or more and 50 nm or less.

4. The positive electrode composite active substance according to claim 1, wherein the coating layer contains phosphorus.

5. The positive electrode composite active substance according to claim 1, wherein the coating layer contains a lithium phosphate-based lithium ion conductive oxide.

6. The positive electrode composite active substance according to claim 5, wherein the lithium ion conductive oxide contains a compound represented by Formula (1) below:
Li_{1+p+q+r}AlₚGa_{q} (Ti, Ge)_{2-p-q}SiᵣP₃₋ᵣO₁₂ , and
the Formula (1) satisfies 0<p≤1, 0≤q<1, and 0≤r≤1.

7. The positive electrode composite active substance according to claim 5, wherein the lithium ion conductive oxide contains a compound represented by Formula (2) below:
LiₐA_{b}D_{c}PO₄ (2), and
in the Formula (2), a, b, and c satisfy 0.9<a<1.1, 0<b≤1, 0≤c<1, and 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

8. The positive electrode composite active substance according to claim 5, wherein the lithium ion conductive oxide contains a compound represented by Formula (3) below and a compound represented by Formula (4) below:
Li_{1+p+q+r}AlₚGa_{q} (Ti, Ge)_{2-p-q}SiᵣP₃₋ᵣO₁₂ (3),
the Formula (3) satisfies 0<p≤1, 0≤q<1, and 0≤r≤1,
LiₐA_{b}D_{c}PO₄ (4), and
in the Formula (4), a, b, and c satisfy 0.9<a<1.1, 0<b≤1, 0≤c<1, and 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

9. The positive electrode composite active substance according to claim 1, wherein the oxide active substance contains a lithium manganese-based oxide having a spinel-type crystal structure.

10. A lithium ion secondary battery comprising:
a positive electrode;
a nonaqueous electrolyte solution; and
a negative electrode,
wherein the positive electrode includes a positive electrode composite active substance,
the positive electrode composite active substance includes an oxide active substance and a coating layer covering a surface of the oxide active substance,
the coating layer has lithium ion conductivity,
at least two arcs are calculated when AC impedance measurement is performed at a frequency of 0.1 Hz to 10 kHz and an amplitude of 10 mV in a state of being charged to a charge depth of 50% and a Nyquist plot is calculated, and
a diameter of an arc on a low frequency component side among the two arcs is 3 times or more and 20 times or less larger than a diameter of an arc on a high frequency component side.

11. The lithium ion secondary battery according to claim 10, wherein the negative electrode includes lithium titanate as a negative electrode active material.

12-13. (canceled)

14. A positive electrode composite active substance constituting a part of a positive electrode of a lithium ion secondary battery using a nonaqueous electrolyte solution as an electrolyte, in which a fine particle fluid is added to an oxide active substance and ground to form a coating layer on a surface of the oxide active substance,
wherein the fine particle fluid contains lithium phosphate-based lithium ion conductive oxide particles having an average particle size of 10 nm or less,
a difference between the grain boundary resistance of the coating layer and a grain boundary resistance of a comparative coating layer is 5% or less, the comparative coating layer being formed on the surface of the oxide active substance by grinding a comparative fine particle fluid having an allowable limit amount to the oxide active substance, and
the coating layer is formed by grinding the fine particle fluid in an amount of 50% or less of the allowable limit amount to the oxide active substance.
